(19) United States
(12) Patent Application Publication
(10) Pub. No.: US 2005/0096195 A1
(43) Pub. Date: May 5, 2005

(54) Exercise weight comprising a permeable housing

(76) Inventor: Sylvain Morrissette, Waterville (CA)

Correspondence Address: LESPERANCE & MARTINEAU, 1440 WEST, STE-CATHERINE ROOM 700, MONTREAL, QC, H3G1R8, CA

(21) Appl. No.: 10/973,301

(22) Filed: Oct. 27, 2004

Related U.S. Application Data
(60) Provisional application No. 60/515,116, filed on Oct. 29, 2003.

(51) Int. Cl. A63B 21/06; B65B 1/04; B67C 3/00

(52) U.S. Cl. 482/93

(57) ABSTRACT

The exercise weight includes a housing containing a filler material of the type which can be poured in a paste-like state into the housing and set therein. The housing includes at least two housing portions which can be attached to each other to define an inner chamber for containing the filler material. The housing also includes an opening for pouring the filler material in the inner chamber, and a permeable seam between the two housing portions, for allowing non filler material fluids to be evacuated from the inner chamber while preventing the filler material from seeping out of the inner chamber.

### CROSS-REFERENCE DATA

The present application claims priority under the Paris Convention of provisional patent application No. 60/515,116 filed on Oct. 29, 2003, under the name of the present inventor.

### FIELD OF THE INVENTION

The present invention relates to exercise weights, and more particularly to an exercise weight having a permeable housing.

### BACKGROUND OF THE INVENTION

Conventional exercise weights comprise a housing usually made of plastic, molded through a blow-molding process, to form a unitary housing wall that will define an inner chamber in which a filler material will be poured. The filler material is a high-density material, usually cement, which is poured in a soft, paste-like state into the inner chamber where it will set.

One problem related to the conventional exercise weight housings is that they enclose an air-tight inner chamber. Since, the cement will often be at least partly heterogeneous, some water will not be properly mixed and will remain in liquid state. This is undesirable, since it will result in shifts of the mass repartition within the housing, which are often relatively small, but which tend to reduce the impression of quality of the product for consumers. More importantly, when producing the exercise weight, a certain drying time is necessary after the cement has been poured in the housing for the cement to set. This idle time increases the total production time of exercise weight, and consequently its production cost. Having an air-tight or substantially air-tight inner chamber increases the drying time, and consequently the production cost, of the exercise weight.

### SUMMARY OF THE INVENTION

The present invention relates to a housing for containing a filler material of the type which can be poured in a paste-like state into said housing and set therein, said housing comprising:
at least two housing portions which can be attached to each other to define an inner chamber for containing said filler material; and
a permeable seam between said two housing portions, for allowing non-filler material fluids to be evacuated from said inner chamber while preventing the filler material from seeping out of said inner chamber.

In one embodiment, the housing further comprises an opening for pouring the filler material in said inner chamber.

In one embodiment, said permeable seam extends substantially peripherally all around said housing.

In one embodiment, said housing further comprises a plug attachable to said housing for closing said opening once the filler material has been poured in said inner chamber.

In one embodiment, said at least two housing portions are made of injection-molded plastic.

The present invention also relates to an exercise weight comprising a housing and a filler material contained in said housing, said housing comprising:
first and second housing portions in facing register with each other that define an inner chamber containing said filler material;
fastening means fastening said first and second housing portions relative to each other;
an opening for pouring the filler material in said inner chamber; and
a permeable seam between said first and second housing portions, for allowing non filler material fluids to be evacuated from said inner chamber while preventing said filler material from seeping out of said inner chamber.

The invention further relates to a method for making an exercise weight comprising the following steps:
providing at least two complementary housing portions;
assembling said at least two housing portions in facing register relative to each other so as to define a housing having an inner chamber circumscribed by said at least two housing portions;
creating a permeable seam between said two housing portions while said at least two housing portions are assembled;
pouring a paste-like filler material in said inner chamber;
allowing said filler material to set within said housing while allowing non filler material fluids in said inner chamber to be evacuated through said permeable seam; and
providing attachment means attaching said at least two housing portions to each other.

In one embodiment, the step of providing at least two housing portions is accomplished by molding plastic material to produce said at least two housing portions by an injection molding process.

### DESCRIPTION OF THE DRAWINGS

In the annexed drawings:

FIG. 1 is a perspective view of an exercise weight according to the present invention;

FIG. 2 is a top plan view of the exercise weight of FIG. 1;

FIG. 3 is a cross-sectional view taken along line III-III of FIG. 2;

FIG. 4 is an enlarged view of the area circumscribed the by line IV of FIG. 3; and

FIG. 5 is similar to FIG. 4, although it is not in cross-section and consequently the peripheral wall of the exercise weight can be seen.

### DETAILED DESCRIPTION OF THE EMBODIMENTS

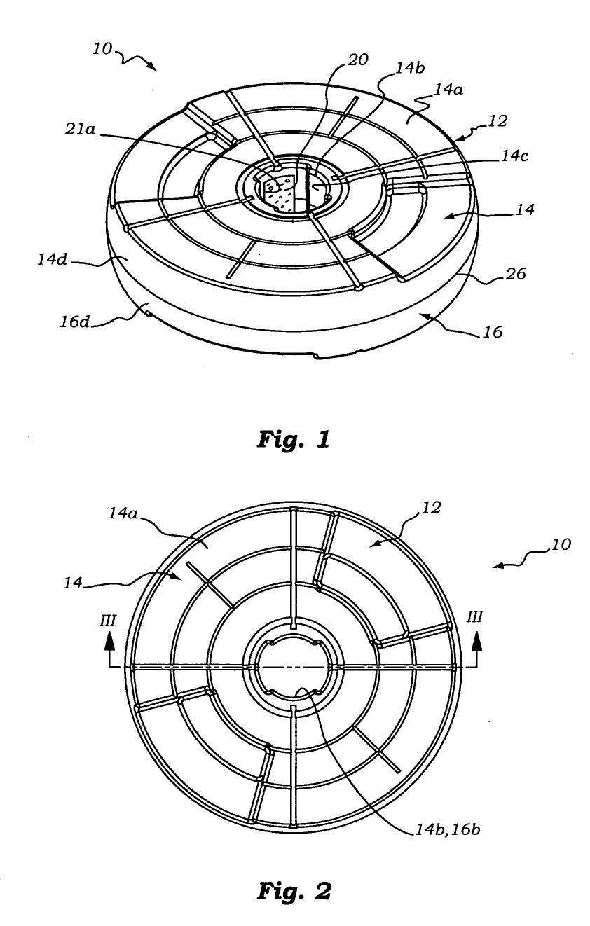

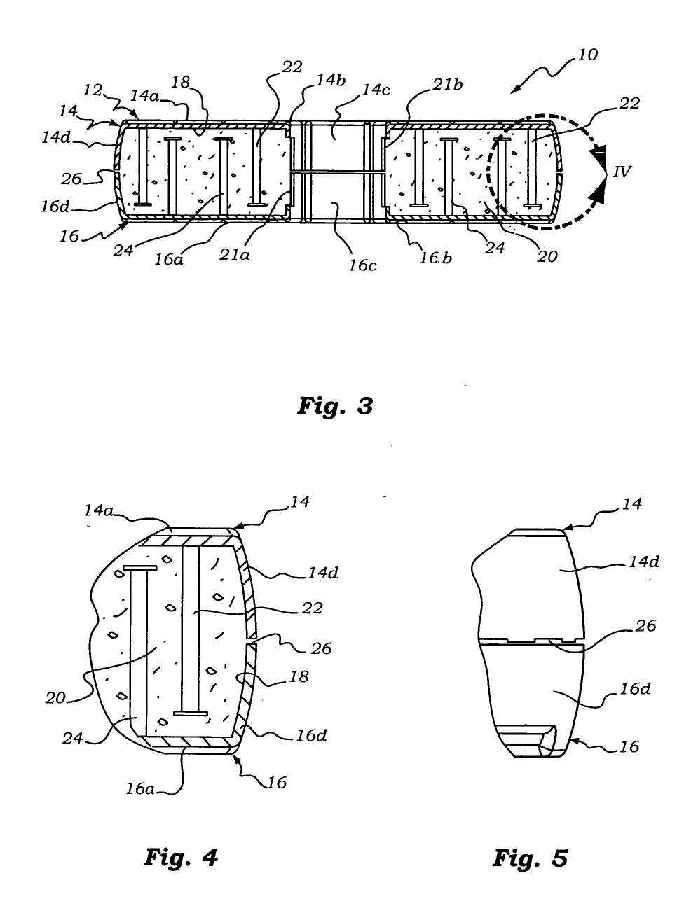

FIGS. 1-5 show an exercise weight 10 according to one embodiment of the invention. Exercise weight 10 comprises a housing 12 having complementary first and second housing portions 14, 16 which are positioned in facing register with each other to define an inner chamber 18. More particularly, first and second housing portions 14, 16 comprise respective first and second annular walls 14a, 16a defining central holes 14b, 16b. Inner first and second peripheral walls 14c, 16c and outer first and second peripheral walls 14d, 16d protrude from the respective first and second annular walls 14a, 16a. First and second housing portions 14, 16 are assembled by having the edges of the inner annular walls 14c, 16c abut against each other, and by having the edges of the outer annular walls 14d, 16d also abut against each other.

Inner chamber 18 is consequently generally annular, and is defined within the generally concave inner surfaces of first and second housing portions 14, 16 which are in facing register with each other.

A filler material 20 is inserted in inner chamber 18. A pair of filling openings 21a, 21b is provided on the inner peripheral wall 14b, 16b of housing 12. Filler material can be poured through openings 21a, 21b. Plugs (not shown) can be provided to close openings 21a, 21b.

Filler material 20 can be of any suitable type, although in practice low-cost high-density filler materials are used which have the capacity to remain immobile within housing 12 to prevent the center of gravity of weight 10 from moving relative to housing 12. A typical filler material is cement, which can be poured into inner chamber 18 while it is in a fresh, paste-like state. Once in inner chamber 18, the cement will be allowed to set, thus becoming a rigid, solid mass within housing 12.

Exercise weight 10 further comprises fastening means fastening the first and second housing portions 14, 16 relative to each other. More particularly, the fastening means can be any type of means by which the position of the first housing portion is set relative to the position of the second housing portion. The fastening means shown in the drawings comprise a number of first and second pins 22, 24 respectively attached to the first and second housing portions 14, 16 and protruding within inner chamber 18. Pins 22, 24 become embedded in the cement as the latter is poured in inner chamber 18 and sets therein. Alternate fastening means can include: complementary cooperating clips on the first and second housing portions 14, 16 that allow them to be clipped to each other; strips or wires that are attached to both housing portions 14, 16; complementary press-fitted elements that are provided on first and second housing portions 14, 16; or generally any means provided on first and/or second housing portions 14, 16, that will allow the position of first housing portion 14 to be set relative to second housing portion 16 through the instrumentality of the filler material or not.

According to the present invention, a permeable seam 26 exists between first and second housing portions 14, 16, for allowing fluids to be evacuated from inner chamber 18 while preventing filler material 20 from seeping out of inner chamber 18. More particularly, permeable seam 26 is created by allowing a small opening to exist between first and second housing portions 14, 16 about a non-negligible portion of the periphery of housing 12. In the embodiment shown in FIGS. 1-5, this seam is obtained by providing a crenelated lower edge on the first housing portion inner and outer peripheral walls 14c, 14d. (Only a the crenelations of the first housing portion outer peripheral wall 14d is shown in the drawings—and more specifically in FIG. 5). These crenelations allow small gaps to exist between the first housing portion 14 and the second housing portion 16 around all the periphery of housing 12. It could be envisioned to provide similar crenelations on the second housing peripheral walls 16c, 16d. Alternate permeable seams could also be provided where the seams would include openings that extend around the whole periphery of housing 12 in an uninterrupted manner, or around a substantial portion of the periphery of housing 12 without however extending about the whole periphery thereof.

One advantage of providing a permeable seam on housing 12 is that it allows fluids within inner chamber 18 to be evacuated by seeping through seam 26. This is especially advantageous when considering that the cement being poured in housing 12 will comprise the usual mixture of granular lime-based powder and water. As stated in the Background of the Invention section of the present specification, it is common for the cement to be at least partly heterogeneous, in that some water will not be properly mixed. In practice, this often yields some free liquid-state water being present within the exercise weight housing. This is undesirable, since it will result in shifts of the mass repartition within the housing, which are often relatively small, but which tend to reduce the impression of quality of the product for consumers. More importantly, when producing the exercise weight, a certain drying time is necessary after the cement has been poured in housing 12 for the cement to set. This idle time increases the total production time of exercise weight 10. Consequently, by providing a permeable seam 26 on housing 12, the drying time is reduced since liquid-state water is allowed to seep out of housing 12, since gazeous-state evaporated water can also flow out of housing 12, and since dry air can flow into housing 12. It is understood that providing a shorter drying time decreases the production costs of each exercise weight.

Also, permeable seam 26 will generally facilitate the pouring of the cement in the housing inner chamber 18 since air inside inner chamber 18 will be allowed to exit inner chamber 18 through seam 26 during the pouring operation, thus preventing any hindrance to the pouring of the cement in inner chamber 18 due to pressure increase therein.

Consequently, permeable seam 26 allows non-filler material fluids to be evacuated from inner chamber 18, including water which may be poured concurrently with the filler material, air present in inner chamber 18 before the filler material is poured in housing 12, or other fluids that may originate from the filler material or not. The filler material is understood as including the material which will set within inner chamber 18, and consequently other fluids such as water which remains from an initial volume of water used to create the filler material and that may be poured concurrently with the filler material or which may ooze from the filler material before it sets completely, is considered to be non-filler material fluid.

The method for making an exercise weight according to the present invention can comprise the following steps:
providing first and second housing portions;
assembling the first and second housing portions in facing register relative to each other so as to define a housing having an inner chamber circumscribed by the first and second housing portions;
creating a permeable seam between the first and second housing portions while the first and second housing portions are assembled;
pouring a paste-like filler material in the inner chamber through an opening made in the housing;
allowing the filler material to set within the housing while allowing non filler material fluids in the inner chamber to be evacuated through the permeable seam; and
providing attachment means attaching the first and second housing portions to each other.

In one embodiment, the step of providing first and second housing portions is accomplished by molding plastic material to produce the first and second housing portions by an injection molding process. This is advantageous over the known blow molding processes, since injection molding allows for more precision in the housing design such as relief on the outside surface of the housing.

In one embodiment, the exercise weight housing could be made of more than two housing portions. In such a case, the permeable seam could extend along two or more of the housing portions.

In one embodiment, the housing could comprise one cup-like housing portion in which the filler material is poured, with the other housing portion(s) being attached to the first cup-like housing portion after the filler material is poured therein. This would circumvent having to provide an opening per se in said housing to pour the filler material, since the latter would be poured before the housing portions are assembled.

1. A housing for containing a filler material of the type which can be poured in a paste-like state into said housing and set therein, said housing comprising:
at least two housing portions which can be attached to each other to define an inner chamber for containing said filler material; and
a permeable seam between said two housing portions, for allowing non-filler material fluids to be evacuated from said inner chamber while preventing the filler material from seeping out of said inner chamber.

2. A housing as defined in claim 1, further comprising an opening for pouring the filler material in said inner chamber.

3. A housing as defined in claim 1, wherein said permeable seam extends substantially peripherally all around said housing.

4. A housing as defined in claim 2, further comprising a plug attachable to said housing for closing said opening once the filler material has been poured in said inner chamber.

5. A housing as defined in claim 1, wherein said at least two housing portions are made of injection-molded plastic.

6. An exercise weight comprising a housing and a filler material contained in said housing, said housing comprising:
first and second housing portions in facing register with each other that define an inner chamber containing said filler material;
fastening means fastening said first and second housing portions relative to each other;
an opening for pouring said filler material in said housing; and
a permeable seam between said first and second housing portions, for allowing non-filler material fluids to be evacuated from said inner chamber while preventing said filler material from seeping out of said inner chamber.

7. A housing as defined in claim 6, wherein said permeable seam extends substantially peripherally all around said housing.

8. A housing as defined in claim 6, further comprising a plug attachable to said housing and for closing said opening once said filler material has been poured in said inner chamber.

9. A housing as defined in claim 6, wherein said first and second housing portions are made of injection-molded plastic.

10. A method for making an exercise weight comprising the following steps:
providing at least two complementary housing portions;
assembling said at least two housing portions in facing register relative to each other so as to define a housing having an inner chamber circumscribed by said at least two housing portions;
creating a permeable seam between said two housing portions while said at least two housing portions are assembled;
pouring a paste-like filler material in said inner chamber;
allowing said filler material to set within said housing while allowing non-filler material fluids in said inner chamber to be evacuated through said permeable seam; and
providing attachment means attaching said at least two housing portions to each other.

11. A method for making an exercise weight according to claim 10, wherein the step of providing at least two housing portions is accomplished by molding plastic material to produce said at least two housing portions by an injection molding process.

12. A method for making an exercise weight according to claim 10, wherein the step of pouring a paste-like filler material in said inner chamber is accomplished through an opening made in said housing.

13. A method for making an exercise weight according to claim 12, further comprising the step of providing a plug for closing said opening.
